(19) United States
(12) Patent Application Publication
(10) Pub. No.: US 2015/0165601 A1
(43) Pub. Date: Jun. 18, 2015

(54) VALVE KEY ASSEMBLIES

(71) Applicant: Karla Braude, Bend, OR (US)

(72) Inventor: Karla Braude, Bend, OR (US)

(21) Appl. No.: 14/572,350

(22) Filed: Dec. 16, 2014

Related U.S. Application Data
(60) Provisional application No. 61/916,585, filed on Dec. 16, 2013.

(51) Int. Cl. B25B 13/50; B25B 13/12; B25B 23/16; B25B 13/48

(52) U.S. Cl. CPC B25B 13/50; B25B 13/481; B25B 13/12; B25B 23/16

(57) ABSTRACT

Valve key assemblies (21) for opening and closing valves. A handle (2), adapted to be turned by a user, is coupled to, and generally perpendicular to, an elongated torque bar (4). Coupled to the torque bar (4) generally perpendicularly is a valve operation head (3) having at least one set of prongs (5) adapted to grasp a handle of a valve. The torque bar (4) can have an adjustable length. The valve operation head (3) can have an adjustable length and/or an adjustable width. The valve operation head (3) can be made to be removable from the torque bar (4), thereby enabling use of the torque bar (4) with a plurality of valve operation heads (3), and therefore with a plurality of different types of valves. A special stand (100) for the valve key assembly (21) has been designed to facilitate storage of the valve key assembly (21).

### RELATED APPLICATION

This patent application claims the benefit of commonly owned U.S. provisional patent application Ser. No. 61/916,585 filed Dec. 16, 2013, which provisional patent application is hereby incorporated by reference in its entirety into the present patent application.

### TECHNICAL FIELD

The present invention generally relates to valve keys and a set of valve key tools to operate valves of differing sizes and types.

### BACKGROUND ART

A typical problem in opening and closing a butterfly type ball valve with a plastic handle, for example, is that one side of the handle has a tendency to break off when operating the side of said handle by hand. Shortly after this, the other side of the handle may break off, due to overuse and weakening of the plastic near the base of the handle. At this point, the entire valve needs to be replaced, incurring a cost for the repair and for the new valve, and furthermore results in down time of the corresponding supply system because the valve needs to be replaced.

### SUMMARY OF THE INVENTION

It is an object of the present invention to provide an apparatus for operating valves with the utmost efficiency. Another object is to provide valve keys and a set of valve key tools adapted to extend the life of the valve. A further object is to provide valve keys and a set of valve key tools that provide customer satisfaction in the process of turning the valve on and off without great effort.

Various embodiments of the invention are directed to valve keys and a set of valve key tools to operate valves of differing sizes and types, as used in typical water or gas supply systems, such as irrigation systems, water lines, and gas lines (natural and/or propane gas). Some of the embodiments described herein are particularly useful in construction, plumbing and/or the field of mechanical engineering and can, e.g., be employed by utility companies and/or service companies.

These and other aspects of the invention will be apparent from and elucidated with reference to the embodiments described hereinafter.

### BRIEF DESCRIPTION OF THE DRAWINGS

In the drawings, like reference numerals refer to like parts throughout the various Figures unless otherwise specified. For a better understanding of the present invention, reference will be made to the following detailed description of preferred embodiments, which is to be read in conjunction with the accompanying drawings, wherein:

FIG. 1 shows a first embodiment of a valve key/tool according to the present invention in a perspective view,

FIG. 2 shows the embodiment of FIG. 1 in a first partial perspective view,

FIG. 3 shows the embodiment of FIG. 1 in a second partial perspective view,

FIG. 4 shows the embodiment of FIG. 1 in a further partial perspective view,

FIG. 5 shows a second embodiment of a valve key/tool according to the present invention in a perspective view,

FIG. 6 shows the embodiment of FIG. 5 in a partial perspective view,

FIG. 7 shows partial perspective views of the embodiments of FIGS. 1-6 together with exemplary valves and valve handles,

FIG. 8 shows an embodiment of a valve key tool set of the present invention in a partial perspective view,

FIG. 9 shows a first embodiment of a valve key assembly according to the valve key tool set according to the embodiment of FIG. 8,

FIG. 10 shows the embodiment of FIG. 9 in a first partial perspective view,

FIG. 11 shows the embodiment of FIG. 9 in a second partial perspective view,

FIG. 12 shows the embodiment of FIG. 9 in a further partial perspective view,

FIG. 13 shows the embodiment of FIG. 9 in a further partial perspective view,

FIG. 14 shows the embodiment of FIG. 9 in a further partial perspective view,

FIG. 15 shows the embodiment of FIG. 9 in a further partial perspective view,

FIG. 16 shows an embodiment of a valve operation head according to the valve key tool set according to the embodiment of FIG. 8,

FIG. 17 shows a second embodiment of a valve key assembly with the valve operation head according to FIG. 16,

FIG. 18 shows the embodiment of FIG. 17 in a partial perspective view,

FIG. 19 shows an embodiment of an L-shaped valve tool handle of the present invention,

FIG. 20 shows a further embodiment of a valve operation head in a schematic plan view,

FIG. 21 shows the embodiment of FIG. 20 in a further schematic plan view,

FIG. 22 shows an embodiment of a stand for a valve key/tool of the present invention in a schematic view, and

FIG. 23 shows an alternative embodiment for connecting a torque bar/rod and a valve operation head of the present invention, in a schematic view.

### DETAILED DESCRIPTION OF PREFERRED EMBODIMENTS

### Definitions

Leverage: The exertion of force by means of a lever or an object used in the manner of a lever.
Torque: A measure of how much a force is acting on an object to cause that object to rotate.
Powder coating: A method for coating metal objects to prevent rusting that has proved to be more efficient than traditional metal coatings, such as painting and galvanizing.
Ball Valve: A one-way valve that is opened and closed by pressure on a ball that fits into a cup-shaped opening.
Gate Valve: A valve with a sliding part that controls the extent of an aperture.
Air Valve: A device for controlling the flow of air in a pipe.
Butterfly Valve: A valve consisting of a pair of semicircular plates that are attached to a spindle across a pipe and hinged to allow flow of a fluid only one-way.
Single Union Valve Plastic or True Union Ball Valve: A valve in which the carrier or main part of the valve can be removed from the associated piping system, to facilitate being either repaired or replaced.
Shut-Off Valve: A valve, usually a ball valve or gate valve, used to shut off the supply of water to a sprinkler system. The shut-off valve is located near the connection to the main water supply.

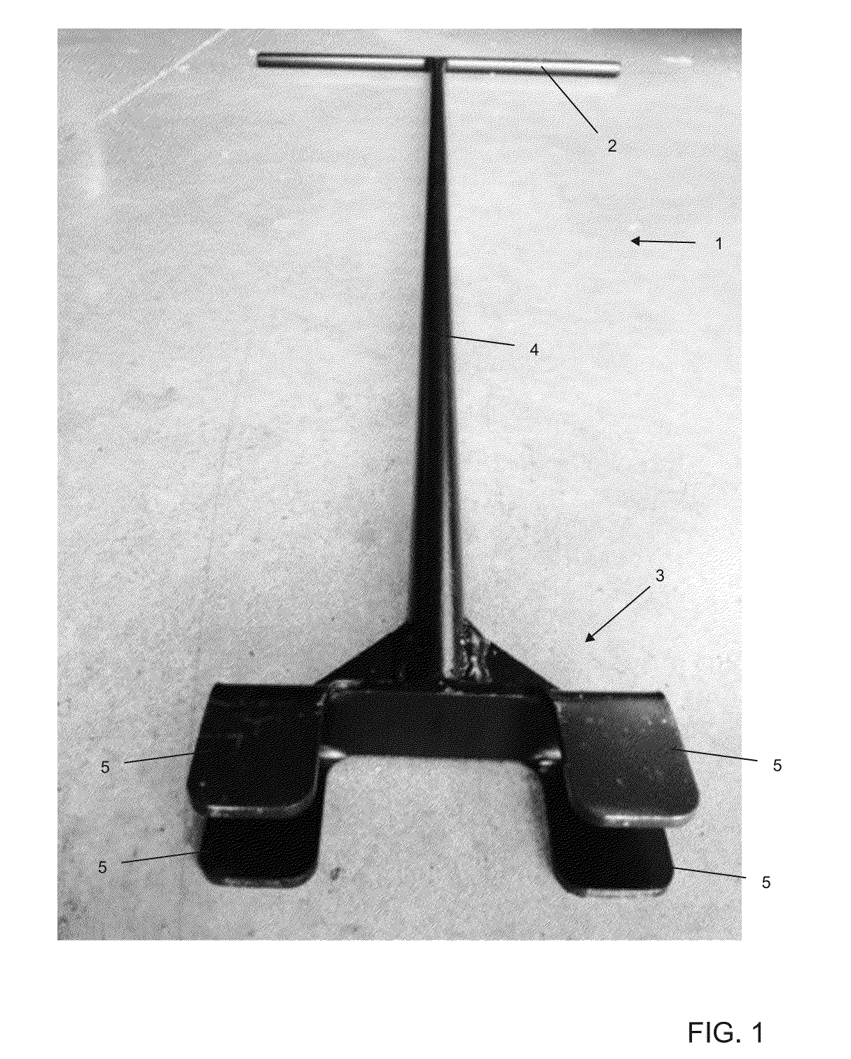

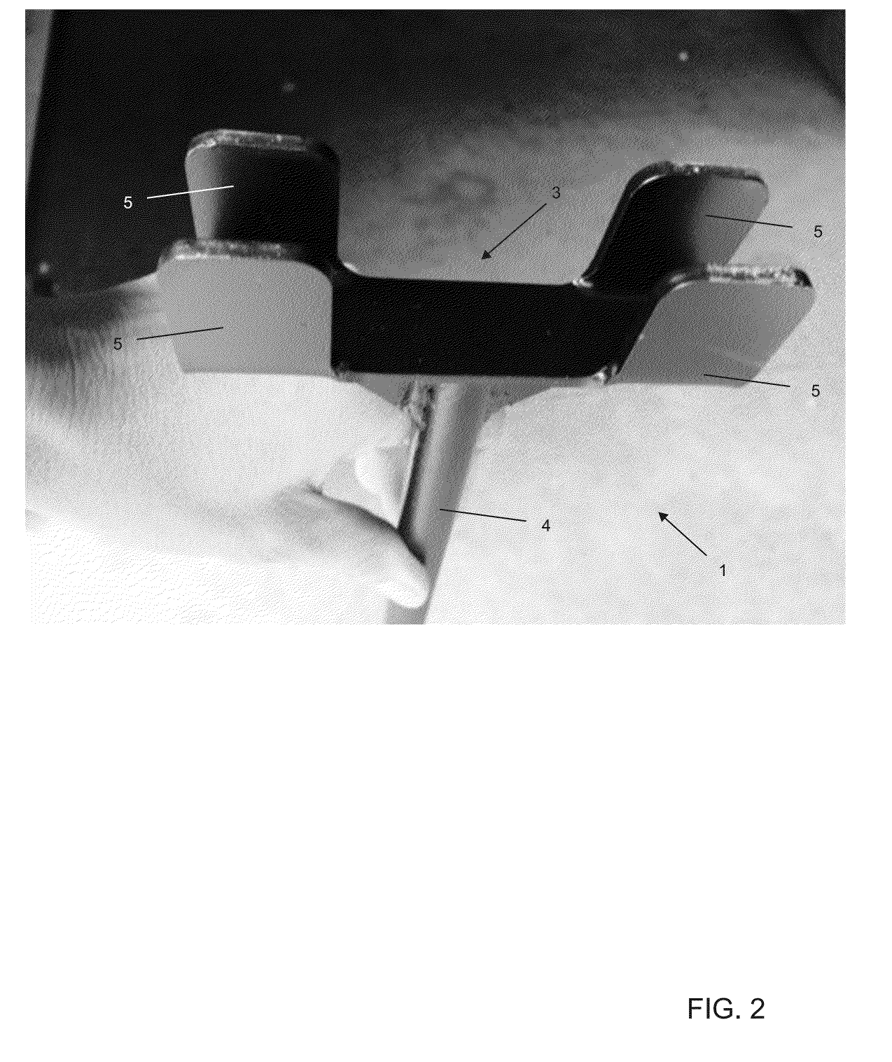

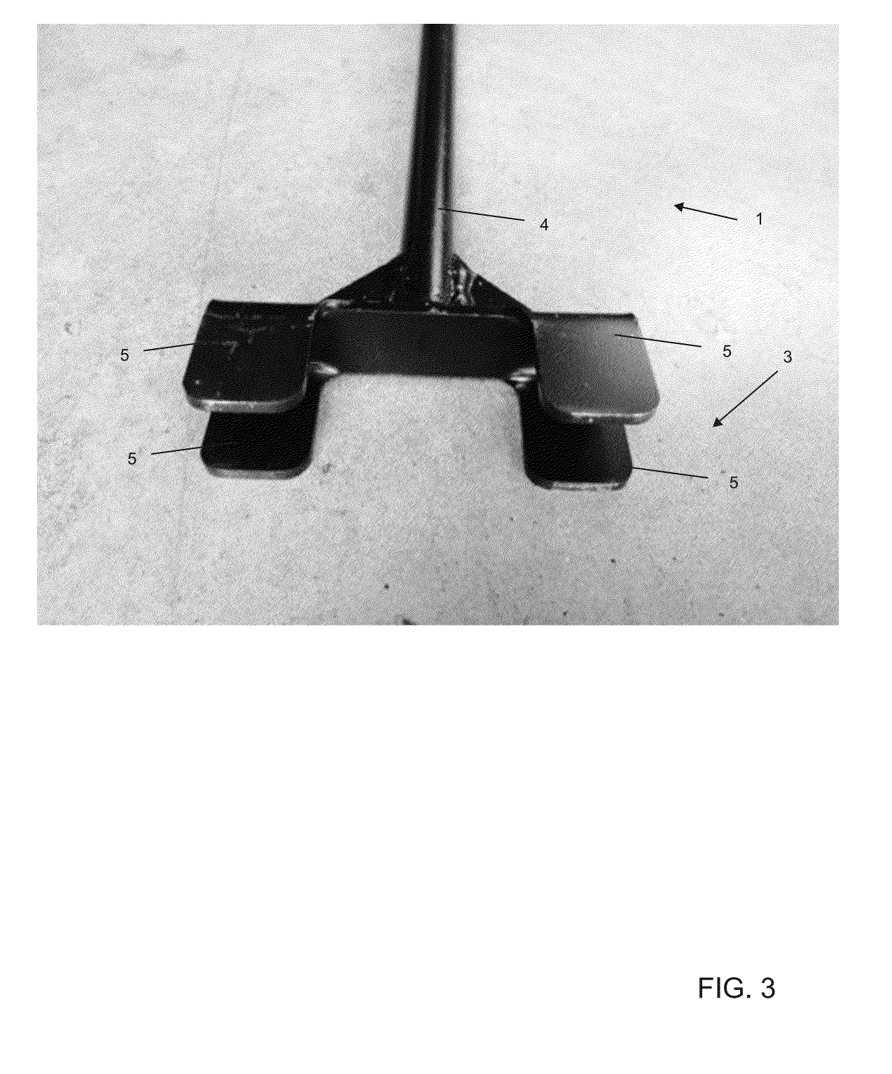

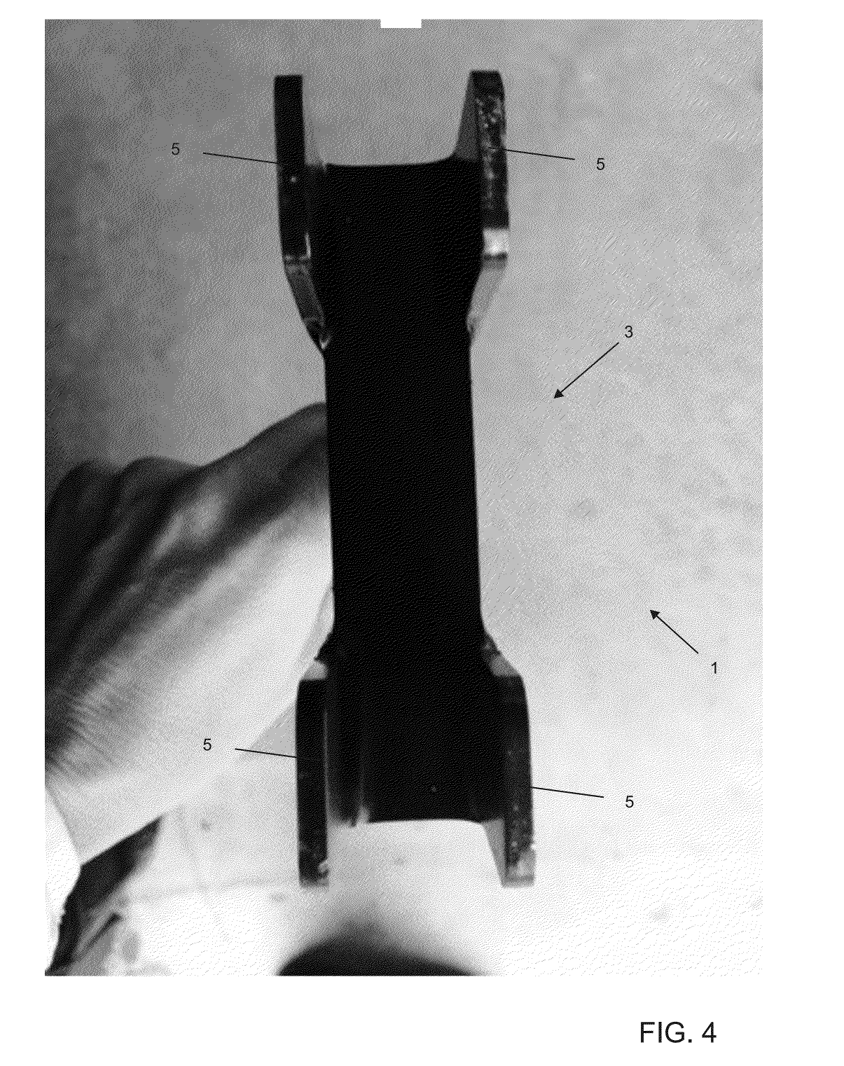

FIGS. 1-4 show a first embodiment of a valve key (valve tool) 1 in various perspective views. The valve key 1 comprises an elongated handle bar 2, which is connected to a valve operation head 3 via a torque bar/rod 4. In the illustrated embodiment, the valve operation head 3 is welded to the torque bar/rod 4 using a triangular reinforcement tab to increase strength, although different connection methods are possible. For example, a steel cylindrical sleeve can be fitted around either handle 2 or bar 4 prior to welding. Valve key 1 is typically made from galvanized steel. Other materials and finishes, such as a powder coating as a surface finish are possible, to improve the rust resistance of valve key 1. The valve operation head 3 according to the present exemplary embodiment is formed integrally with four operating tabs/prongs 5, extending distally from the main body of the valve operation head 3. The prongs 5 are typically grouped in pairs of opposed steel plates.

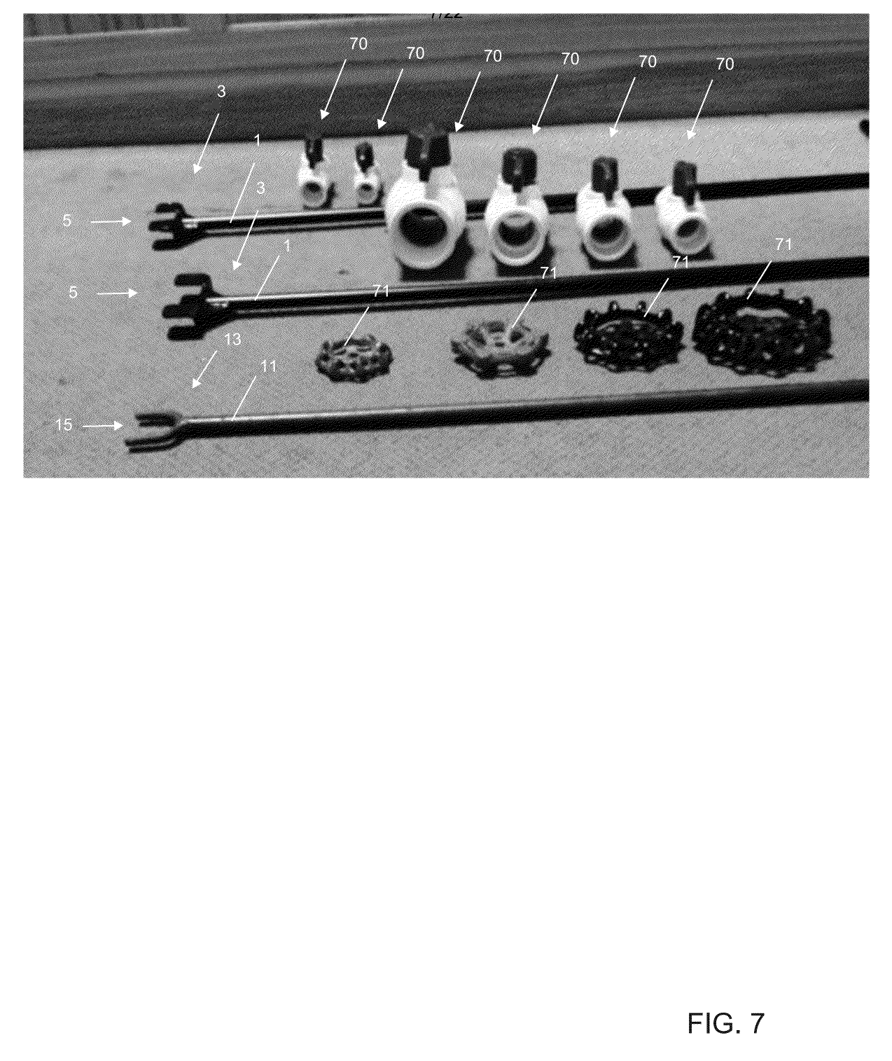

During operation, the user brings the valve operation head 3, and more precisely the operating prongs 5 of the valve operation head 3, into engagement with something that needs to be turned on or off, such as the handle of a typical ball valve 70 as shown in FIG. 7. Using the key 1, valve 70 can easily be operated by twisting the handle bar 2 around an axis parallel to torque bar 4.

The valve key 1 according to the present embodiment—and according to the further embodiments described herein—provides, among other advantages, dual leverage and dual torque in opening and closing valves, because torque can be applied to both ends of the handle of the ball valve 70. Accordingly, the life of the handle of the valve 70 is advantageously increased due to an equal push/pull factor, resulting in decreased cost for replacing broken handles or valves 70. In addition, due to the dual torque design, a user of any age, including women and children, can easily operate even tight valves in inaccessible locations.

Furthermore, the equal leverage (equal application of torque) helps with the initial opening of a closed valve that might be stuck, e.g., in case the valve was not actuated for an extended time, such as over winter. In addition, the valve key 1 allows one to operate valves even if the respective valve is mounted in a nearly inaccessible location, such as in an underground valve box. For example, in an irrigation system, an irrigation riser may be located in such an underground valve box. After watering the ground using the irrigation system, the area around the valve box may be wet or muddy. Accordingly, the valve key 1 according to the present embodiment of the invention effectively keeps the user clean, by not forcing the user to kneel on the ground around the wet or muddy valve box.

The valve key 1 according to the present embodiment of the invention may be adapted to operate ball valves 70 of different sizes. For example, the valve key 1 may be configured with 1 inch by 1.5 inch prongs 5 to operate a multitude of ball valves 70 of ½″ to 8″ size. According to the exemplary embodiment of FIGS. 1-4, the prongs 5 are spaced apart from each other 1.25 of an inch along the longitudinal axis of valve operation head 3, and are spaced apart from each other approximately 1 inch along an axis perpendicular to said longitudinal axis. The aforementioned exemplary configuration of valve key 1 is shown in the perspective view of FIG. 7 together with the corresponding ball valves 70 of various sizes.

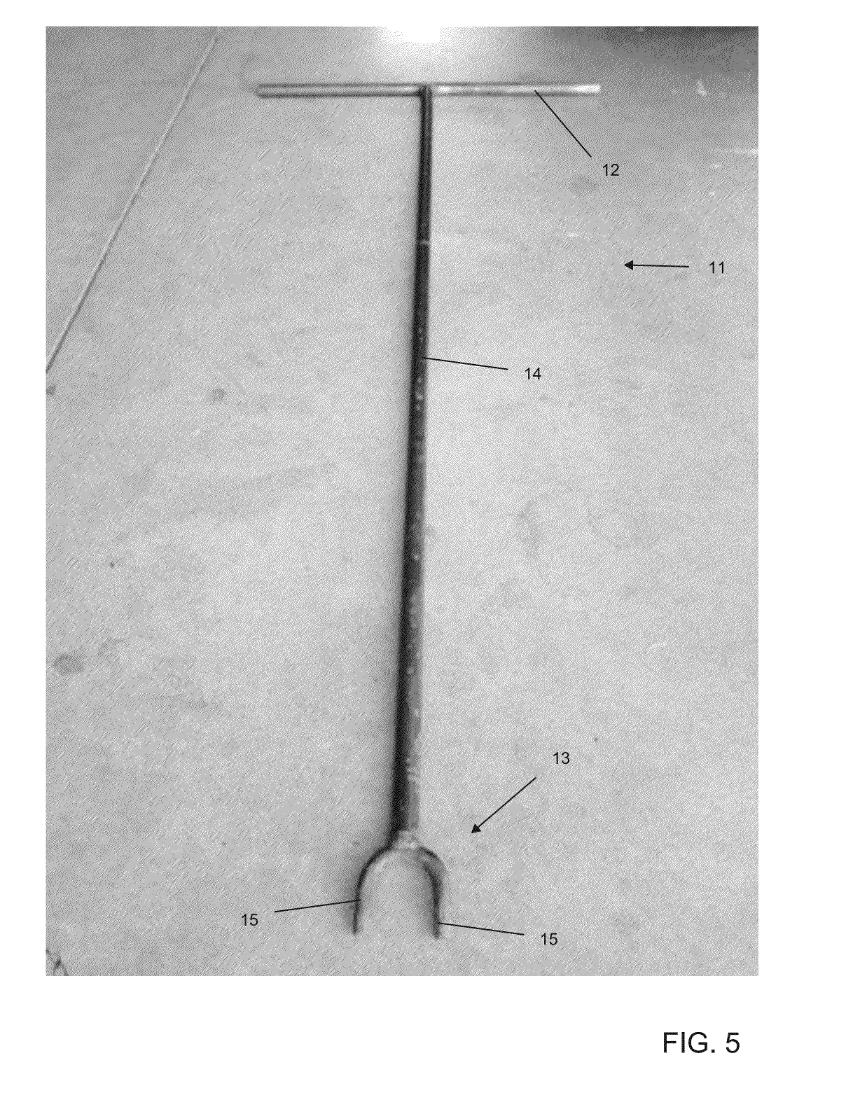

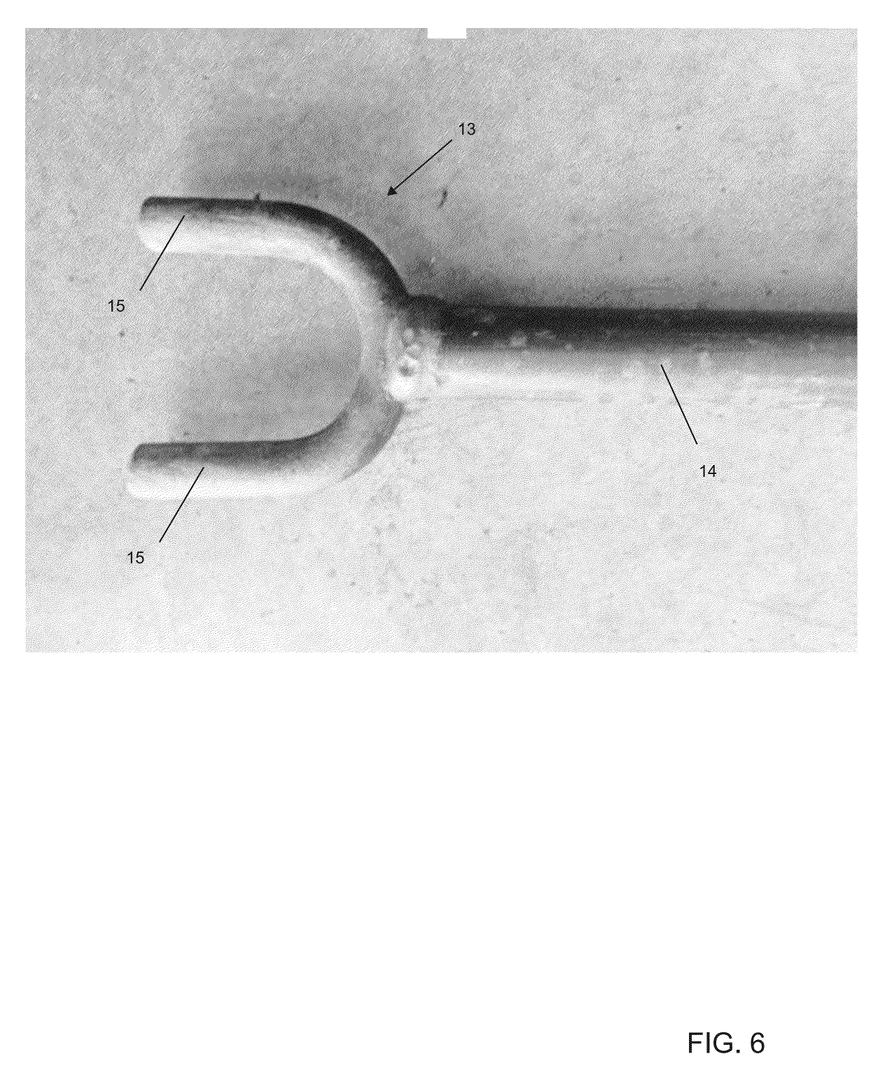

FIGS. 5 and 6 show a second embodiment of a valve key 11 according to the present invention in perspective views. Valve key/tool 11 corresponds to valve key 1 explained with reference to FIGS. 1-4, with the exception of valve operation head 13. As will be apparent from FIGS. 5 and 6, valve operation head 13 in this embodiment comprises a U-shaped, rounded steel tube, having two parallel ends 15. The valve key 11 according to the present example thus is adapted to operate valves having a round handle 71, such as the gate valves shown in FIG. 7.

When operating a gate valve, the user brings the ends 15 of the valve operation head 13 into engagement with openings formed in handle 71. Turning the handle bar 12 of the valve key 11 accordingly operates the valve by transmitting a torque via valve operation head 13 and the handle 71 of the respective valve.

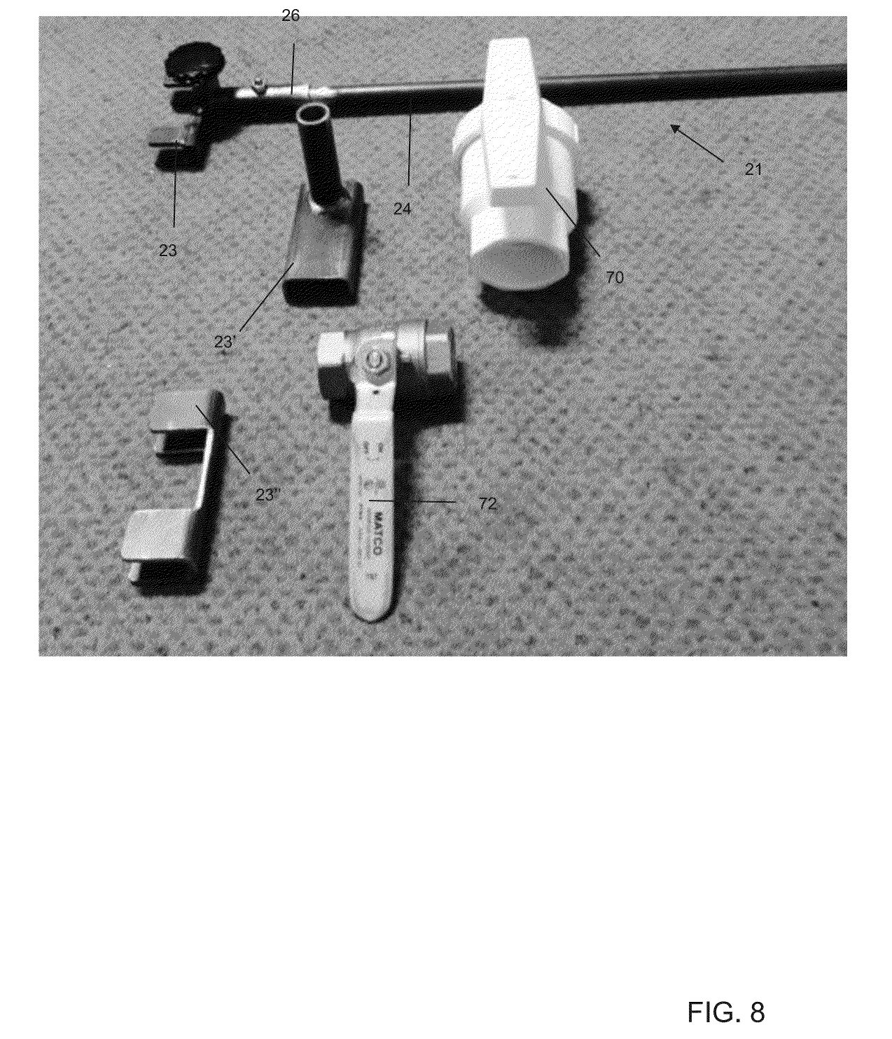

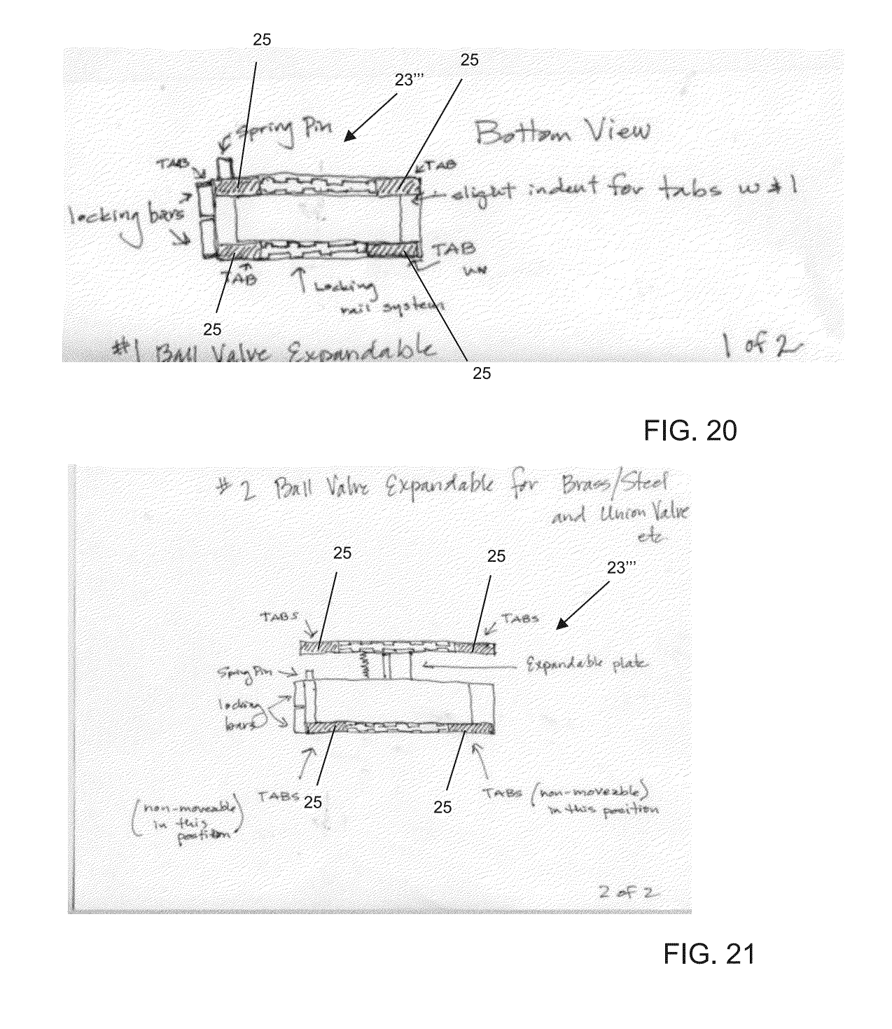

FIG. 8 shows an embodiment of a valve key tool set in a partial perspective view. FIG. 8 corresponds to the embodiments described in the preceding, with the exception that the valve key, referred to as valve key assembly 21, and more precisely the torque bar/rod 24 of the valve key assembly 21, is adapted to connect with exchangeable valve operation heads 23, 23′, 23″, 23′″, 3, and 13, so that the valve key assembly 21 is advantageously usable with a multitude of different valve types, such as ball valve 70, brass/steel ball valve 72, or any other type of ball valve, butterfly valve, gate valve, flange gate valve, and/or air valve. In addition, the present embodiment allows for an exchangeable handle that can be needed for tight spaces, such as crawl spaces under a residential house or other building. The valve key tool set thus corresponds to a “hub system”, allowing one to configure the tool to the respective application or valve. While valve operation head 23 may be adapted to operate valves like ball valve 70 having a centrally hinged handle, valve operation head 23′ can be used to operate valves like brass/steel ball valve 72 having a one-sided hinged handle. Valve operation head 23″ can be used to operate both ball valve 70 and brass/steel ball valve 72. The valve key tool set may alternatively or additionally comprise an exchangeable valve operation head, corresponding to valve operation head 13 of the embodiment of FIGS. 5 and 6 and/or valve operation head 23′″ of FIGS. 20 and 21. Furthermore, the valve key tool set may comprise fewer than all of the shown valve operation heads.

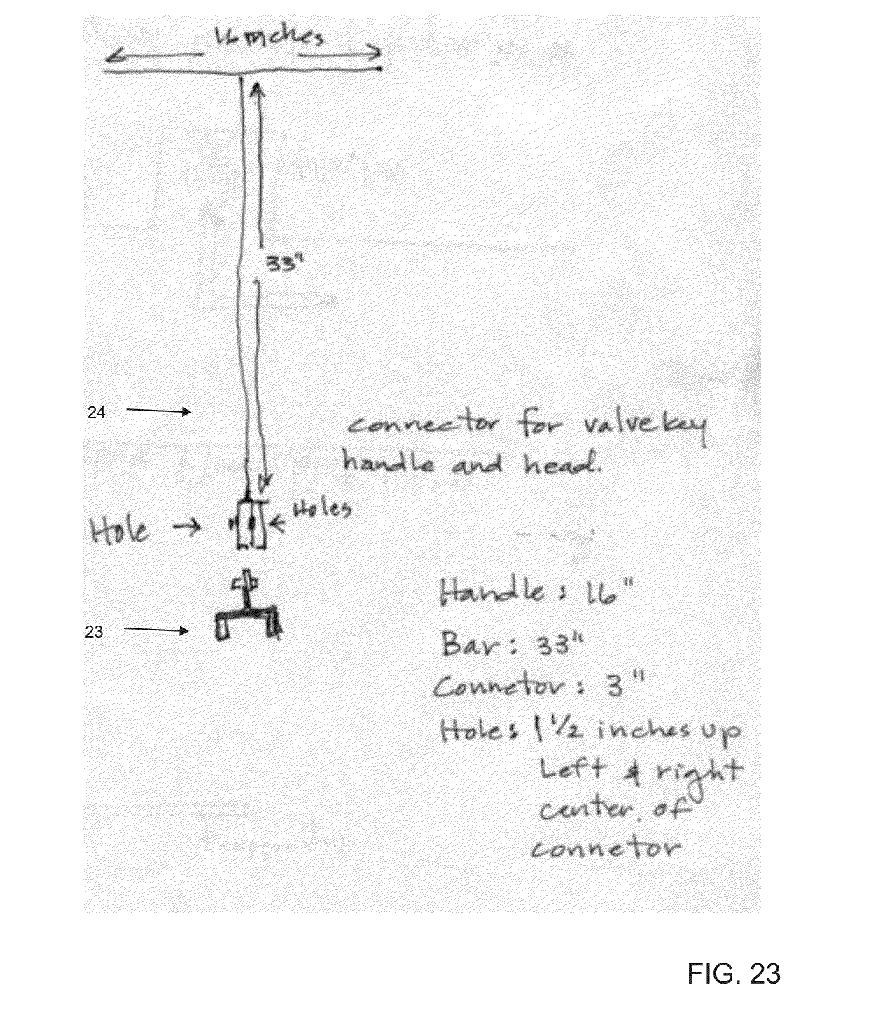

According to the embodiment of FIG. 8, the torque bar/rod 24 is connected to the valve operation head 23 via a receptacle tube 26 portion of the valve operation head 23. The connection is secured using a bolt and nut, arranged in a bore, perpendicular to the axis of torque bar/rod 24. Other techniques can be used to connect torque bar/rod 24 to the valve operation head 23. For example, the valve operation head 23 may be connected to torque bar/rod 24 as shown in FIG. 23 as described below.

Although valve operation head 23″ is shown in FIG. 8 without a receptacle tube, valve operation head 23″ may comprise said receptacle tube 26 or any other suitable connector for connecting to torque bar/rod 24.

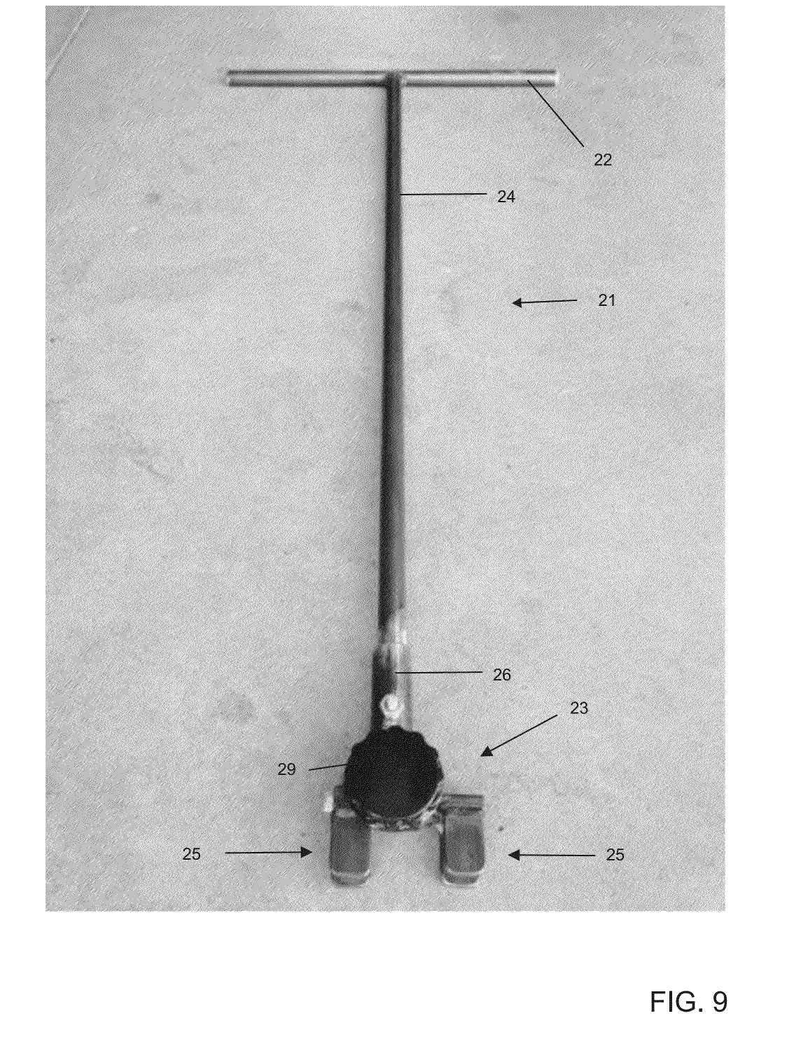

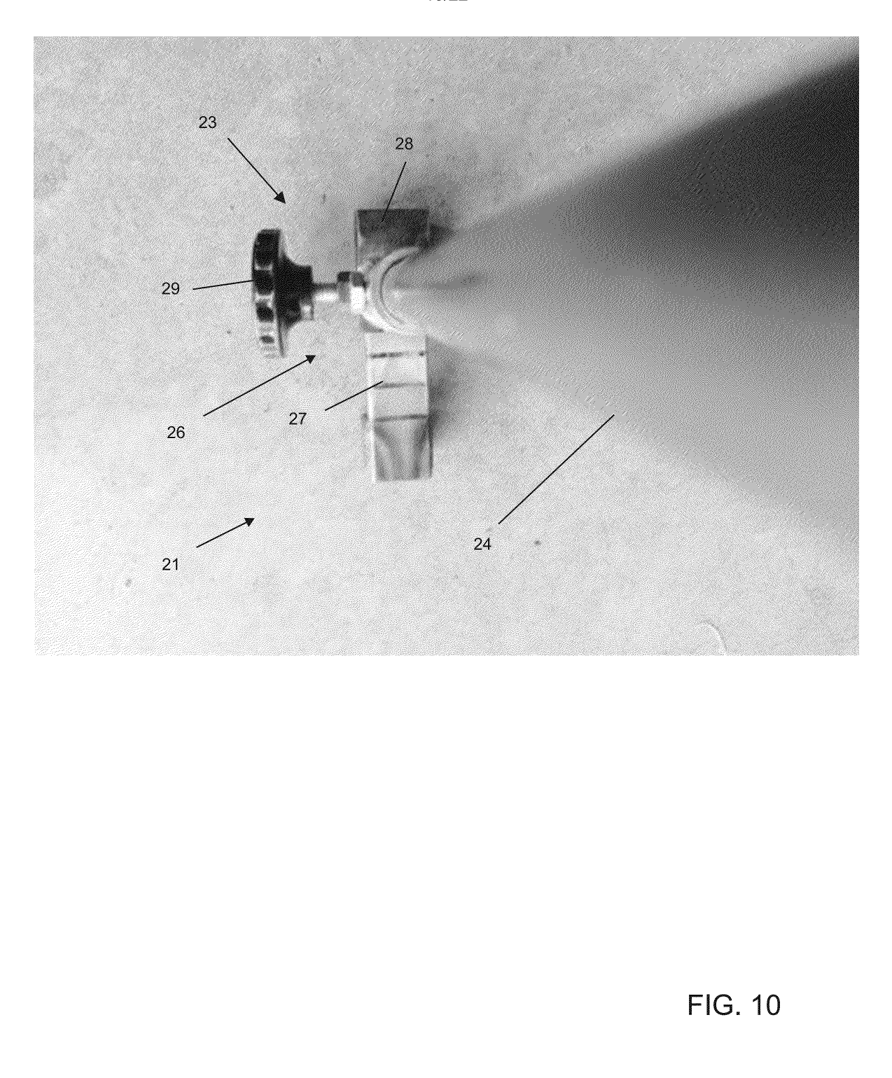

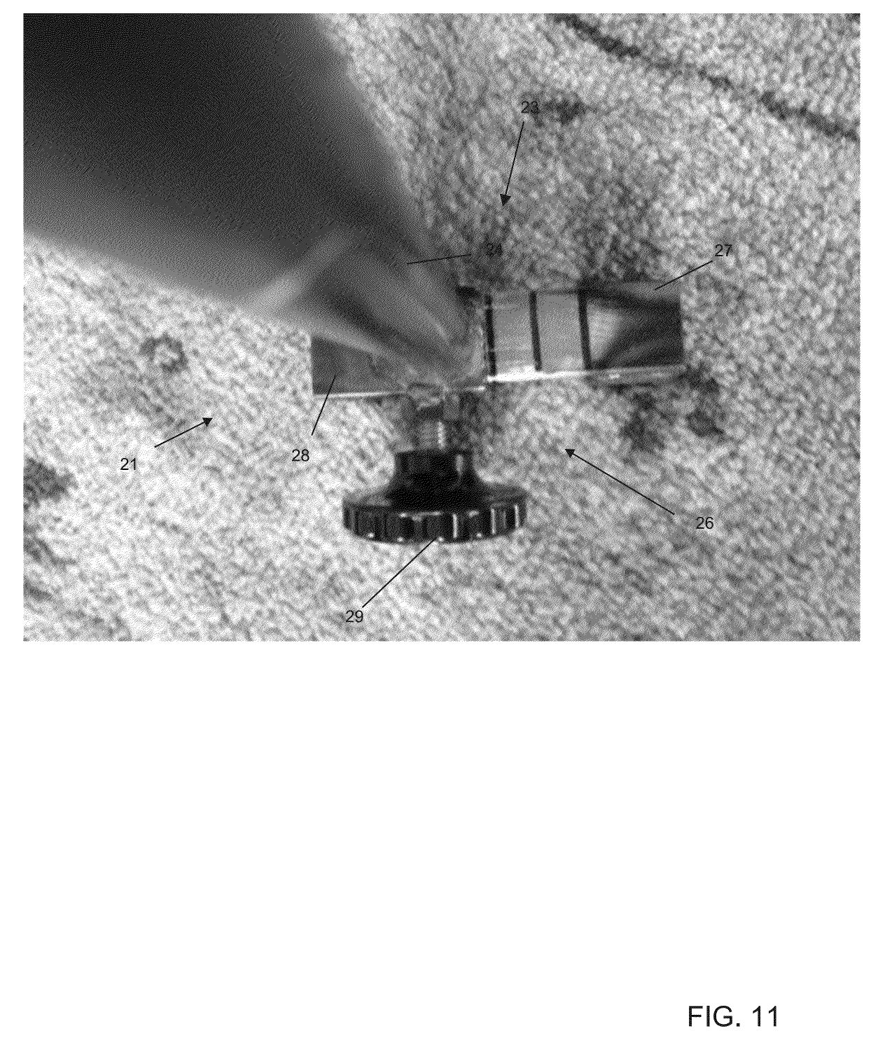

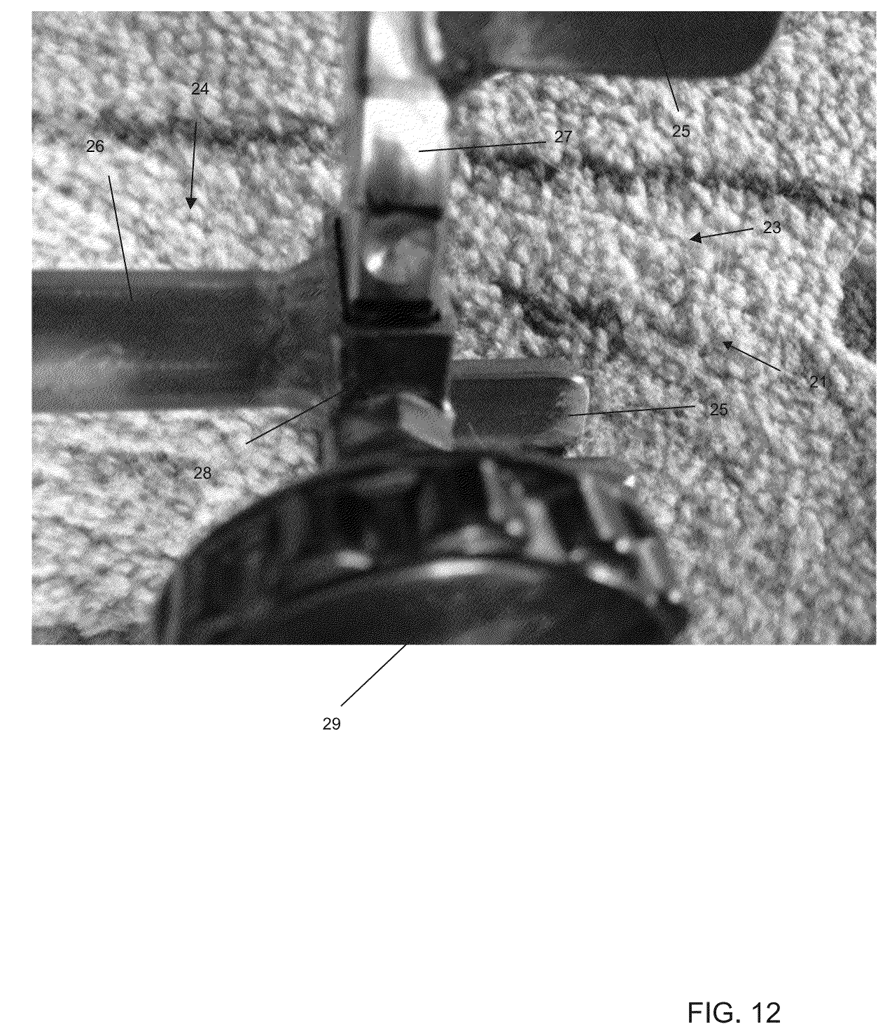

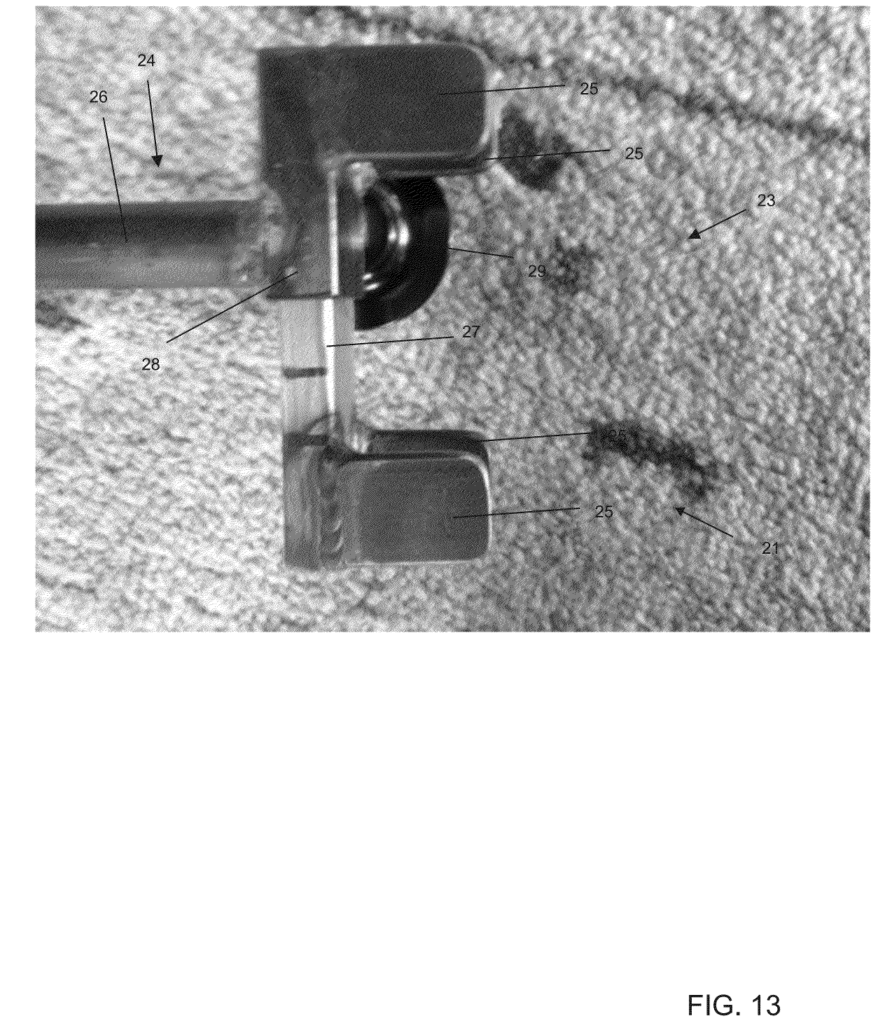

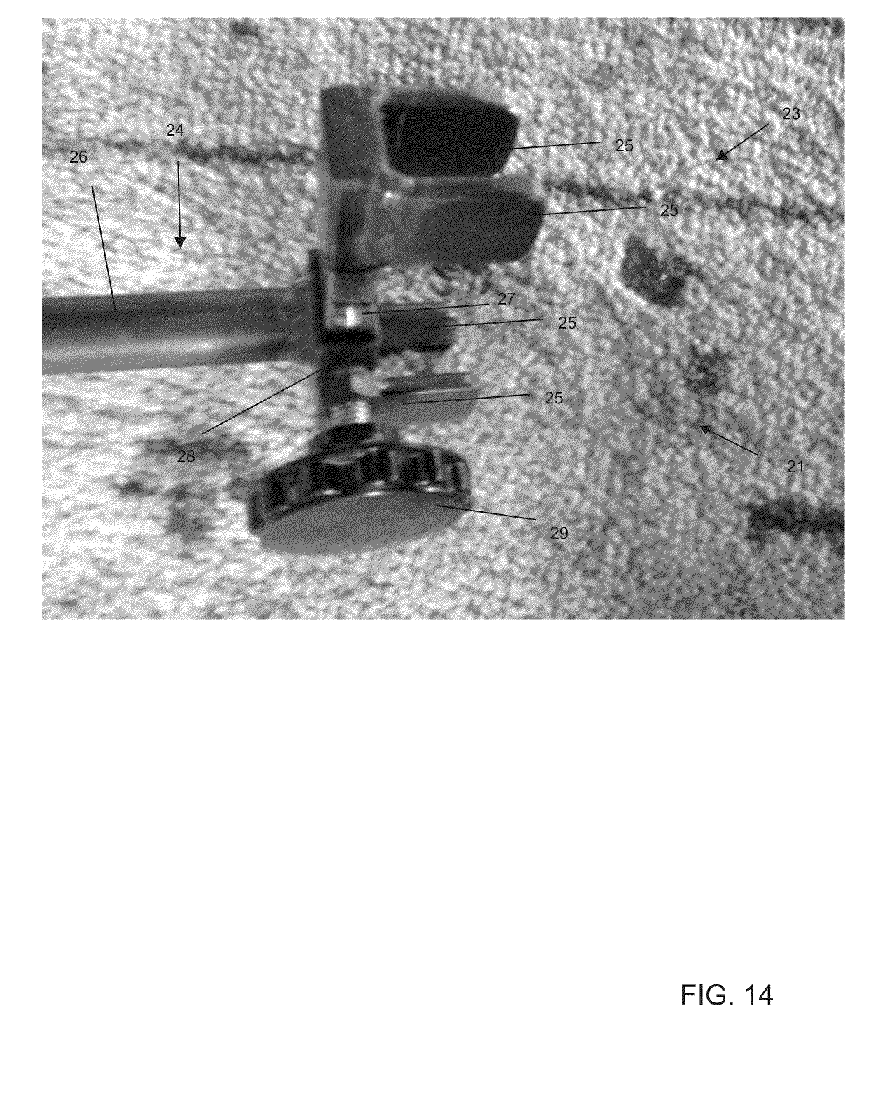

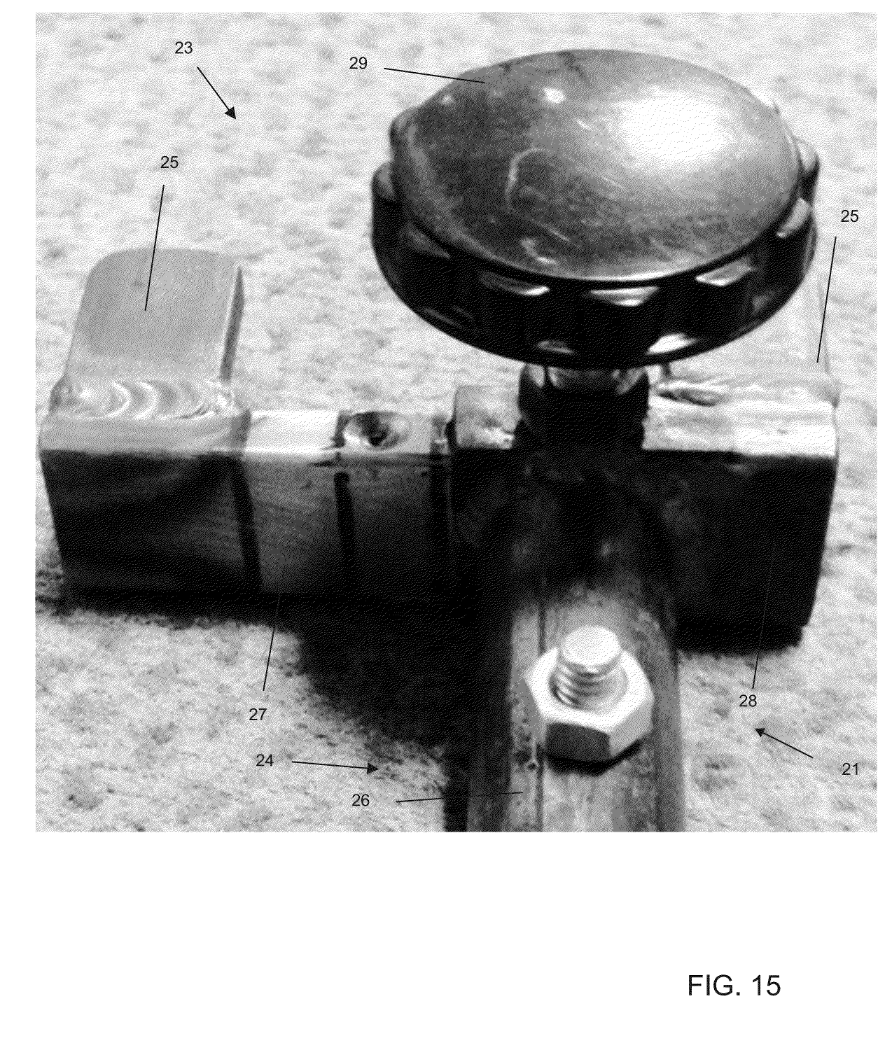

FIGS. 9-15 show the valve key assembly 21 of FIG. 8 in various perspective views. The operation of the valve operation head 23 corresponds to the operation explained with reference to the embodiment of FIGS. 1-4. Correspondingly, prongs 25 of the valve operation head 23 may engage with the handle of a ball valve 70 to operate said valve 70 in a safe and secure manner. In addition, valve operation head 23 allows for length adjustment of the distance between the prongs 25 along a longitudinal axis of valve operation head 23, perpendicular to the axis of torque bar/rod 24. To provide said adjustment, two of said prongs 25 are connected with rail 27 (see FIG. 10), which is movable relative to the body 28 of valve operation head 23. As is apparent in particular from FIGS. 10 and 11, rail 27 comprises markings, indicating an optimal position of rail 27 for different sizes of valves. Markings other than as shown in FIG. 10 can also be used.

The position of rail 27 to body 28 is secured using fixation knob 29, once the rail 27 is brought into the desired position for the respective valve to be operated. Other types of fixation can be used; some of these are discussed below.

The valve operation head 23 according to the embodiment of FIGS. 9-15 allows one tool to be used for a plethora of valves of varying sizes. Accordingly, the present embodiment eliminates the need to carry multiple heavy, cumbersome tools in order to complete a work order.

Additionally or alternatively to the above, valve operation head 23 may be adapted for width adjustment, i.e., adjustment of the spacing between prongs/tabs 25 along an axis lateral to the extension of valve operation head 23. Such a length and width adjustable valve operation head 23′″ is shown in FIGS. 20 and 21. As shown, the valve operation head 23 comprises a rail system for adjusting the length, i.e., the spacing between prongs/tabs 25 along a longitudinal axis of valve operation head 23′″, and an expandable plate for adjusting the width along a lateral axis.

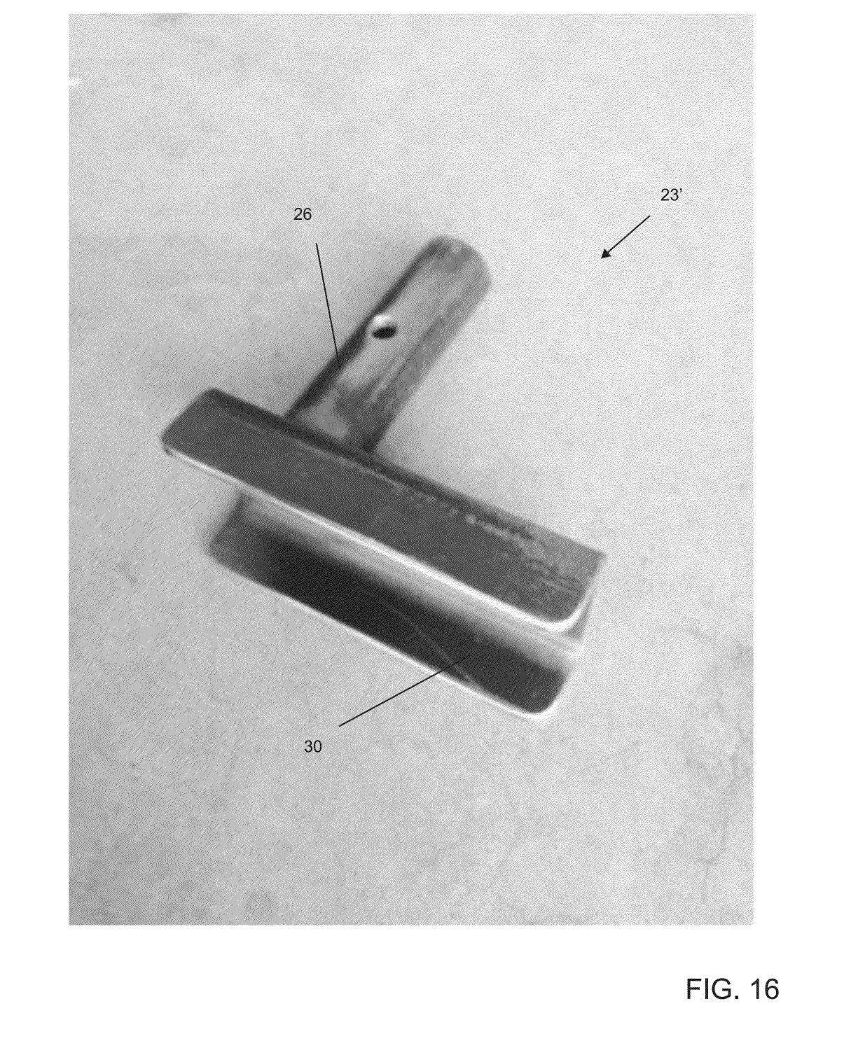

FIG. 16 shows an embodiment of valve operation head 23′ of the valve key tool set shown in FIG. 8. Valve operation head 23′ is particularly adapted to operate the brass/steel ball valves 72 shown in FIG. 8. Valve operation head 23′ comprises receptacle tube 26 for connection to torque bar/rod 24 and a U-shaped operating bar 30. Receptacle tube 26 is arranged off-centered with respect to operating bar 30, to align with the center of rotation of the handle of the brass/steel ball valve 72. The length and width of U-shaped operating bar 30 can be adapted to the size or type of brass/steel ball valve 72. For valve sizes between 2 inches and 10 inches, the U-shaped operating bar 30 may have the following dimensions: 5 inches in length, 1 1/34 inches in width, and 1 1/14 inches in depth, as just one example.

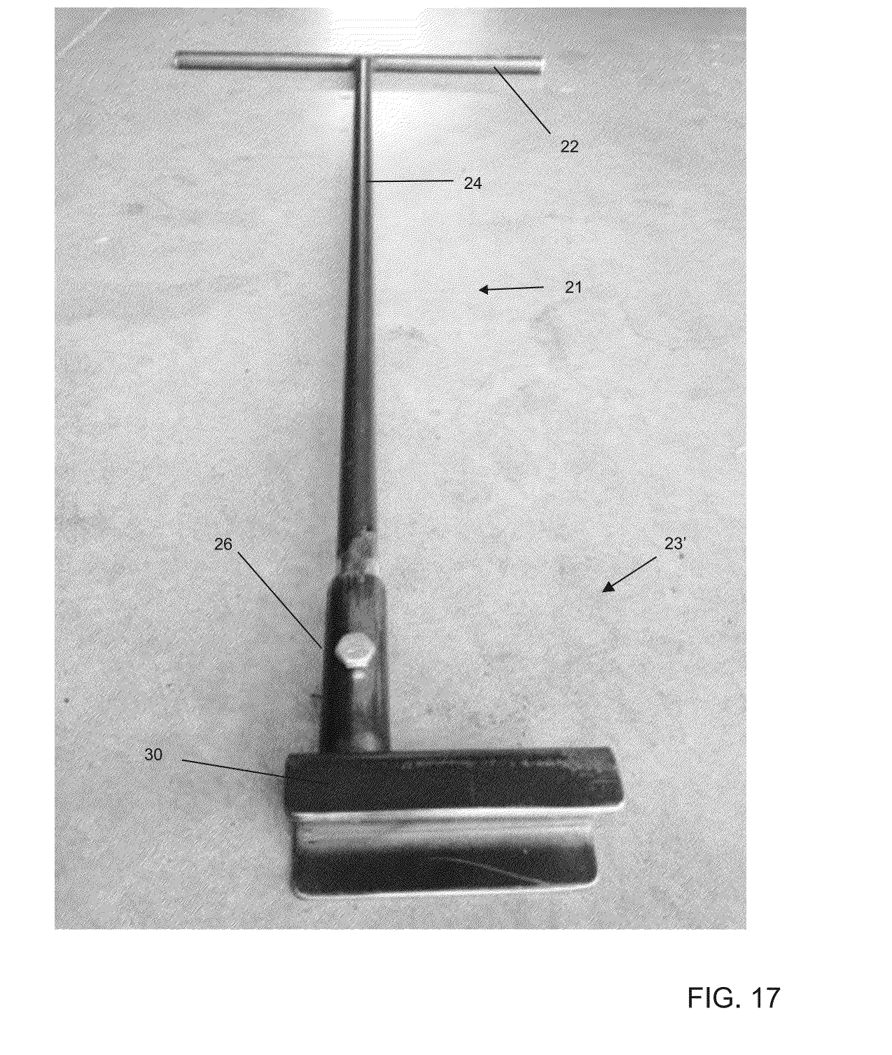

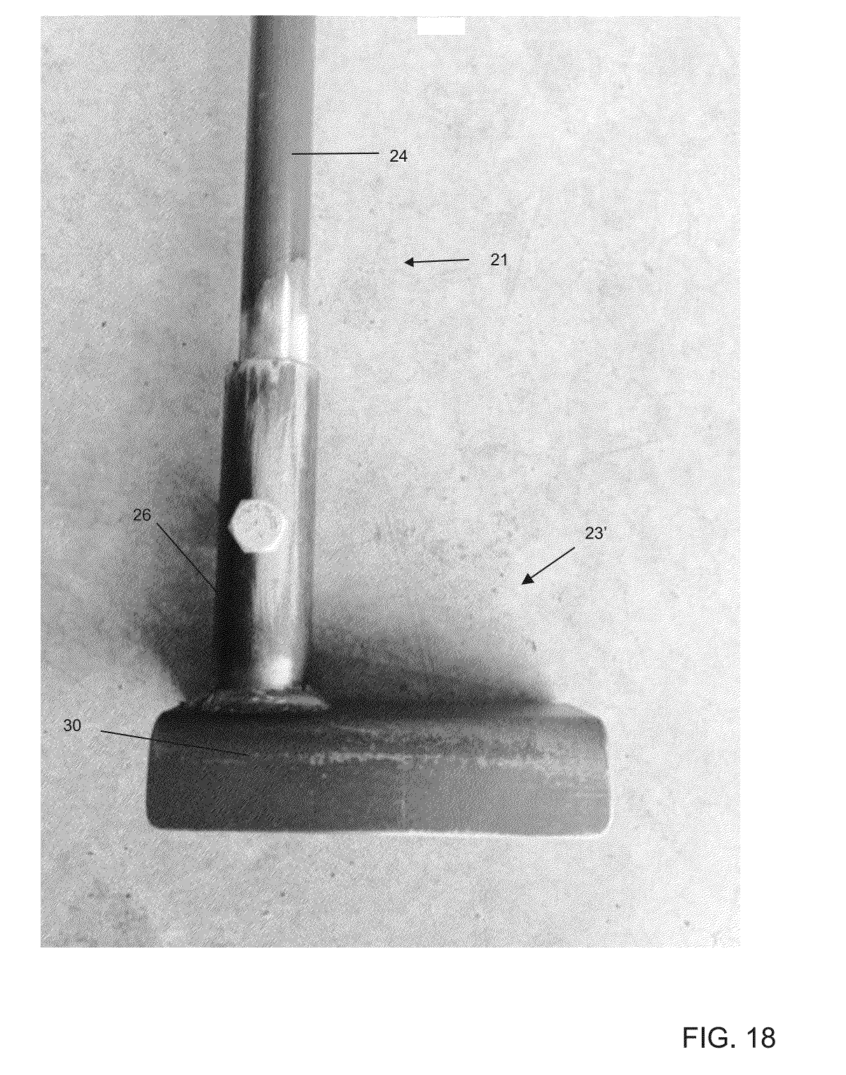

FIGS. 17-18 show the valve operation head 23′ attached to torque bar/rod 24 of valve key assembly 21.

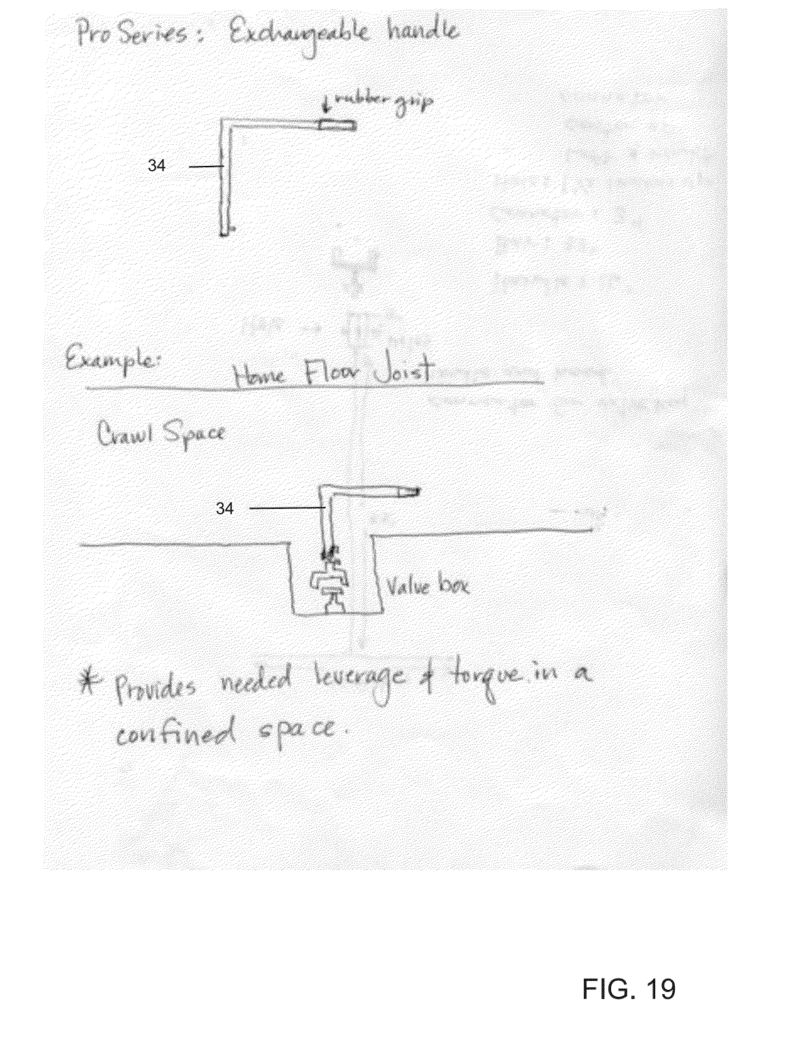

FIG. 19 shows an embodiment of an L-shaped valve tool handle (torque bar) 34. This embodiment is particularly advantageous for use in confined spaces, such as in a crawl space of a residential or commercial dwelling, where space for operating the valve key 1, 11, 21 is limited. Further, the L-shaped torque bar 34 increases the leverage, so that operating of a valve is facilitated. Torque bar 34 may be configured for connection to a valve operation head 23, 23′, 23″, 23′″, 3, or 13 in any suitable way, and in particular according to the any of the methods described herein.

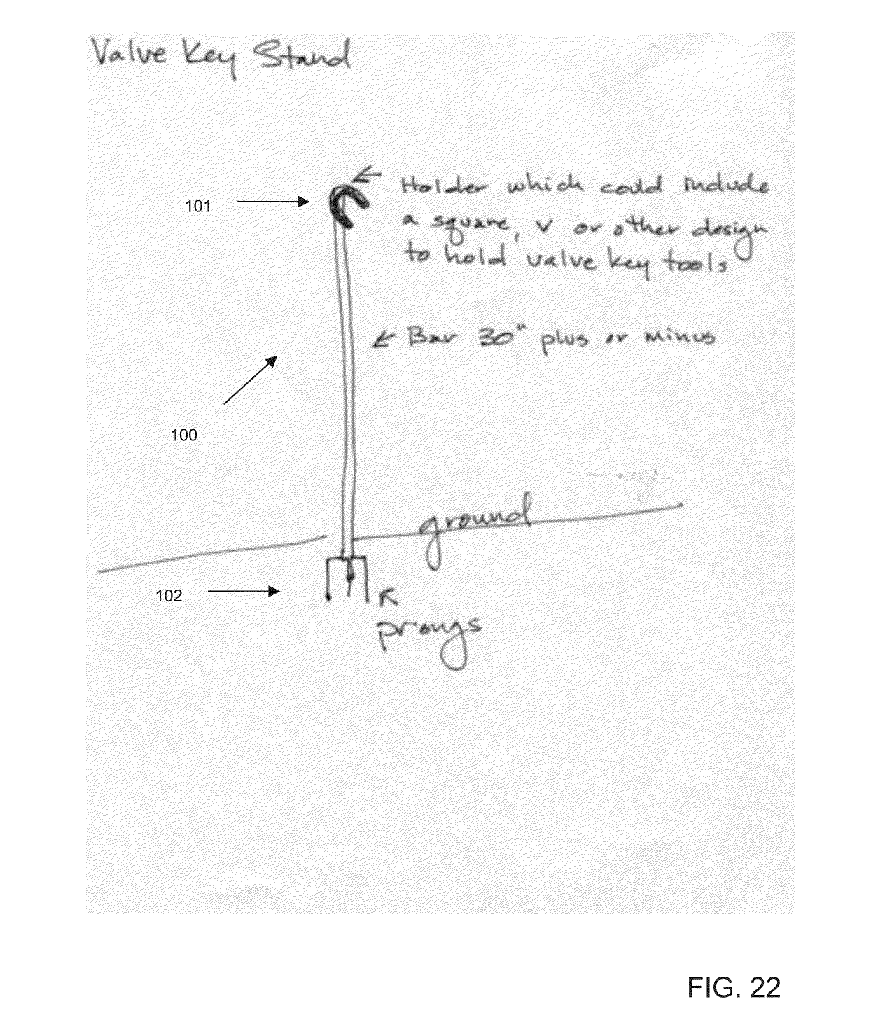

FIG. 22 shows an embodiment of a stand 100 for a valve key 1, 11, 21. Using the stand 100, it is possible to safely store the valve key 1, 11, 21 near the valve to be operated. The stand 100 comprises a holder 101, which can have a round, horseshoe, square, “V”, or other shape, to hold valve key 1, 11, 21 when the valve key not in use. Stand 100 can comprise prongs 102 to secure the stand 100 in the ground or soil.

FIG. 23 shows an alternative embodiment for connecting torque bar/rod 24 to valve operation head 23. As will be apparent, this configuration can be used in conjunction with any of the embodiments of the present invention discussed herein. As can be seen from FIG. 23, torque bar/rod 24 comprises a hollow tube connector at the end proximate to valve operation head 23. The hollow tube comprises several bores or holes, which are arranged perpendicular to the longitudinal axis of torque bar/rod 24. Valve operation head 23 comprises a cylindrical connector, adapted for insertion into the hollow tube connector of torque bar/rod 24. The cylindrical connector comprises at least two spring loaded locking elements, e.g., pins or balls, arranged perpendicular to the longitudinal axis of the cylindrical connector on opposing sides thereof. Upon engagement or insertion of the cylindrical connector into the hollow tube connector of torque bar/rod 24, the locking elements lock into the aforementioned bores to secure the valve operation head 23 to the torque bar/rod 24.

This embodiment is analogous to a locking mechanism used in certain socket wrench/nut driver connections. The geometry of the coupling can be reversed, i.e., the hollow tube connector can be arranged on the side of valve operation head 23 while the cylindrical connector is arranged on the side of torque bar/rod 24.

While the present invention has been illustrated and described in detail in the drawings and foregoing description, such illustration and description are not restrictive; i.e., the invention is not limited to the disclosed embodiments.

For example, it is possible to operate the invention in embodiments, additional or alternative to the above, wherein:
the valve key 1, 11, 21 or parts of the valve key tool set are powder coated;
the valve key 1, 11, 21 or parts of the valve key tool set are made from reinforced heavy-duty structural steel (or steel tubing); in particular, torque bar 4, 14, 24, 34 and handle bar 2, 12, 22 can benefit from this treatment;
the valve key 1, 11, 21 or parts of the valve key tool set can be made from galvanized aluminum; in particular, torque bar 4, 14, 24, 34 and handle bar 2, 12, 22 can benefit from this treatment;
the valve key 1, 11, 21 and/or the valve key handle bar 2, 12, 22 can comprise directional markings, allowing the user to quickly determine open and close directions, which can help prevent breaking the valve handles if turned the wrong way;
the handle bar 2, 12, 22 of the valve key 1, 11, 21 can comprise a rubber, plastic, textile, or other type of coating, and/or ergonomic handle bar grips;
the handle bar 2, 12, 22 of the valve key 1, 11, 21 can be adjustable and/or extendable in length;
the handle bar 2, 12, 22 of the valve key 1, 11, 21 can have a length of 16″;
the torque bar/rod 4, 14, 24, 34 can be configured for telescopic extension and/or comprise other means for length and/or width adjustment, e.g., to accommodate for varying depths of valve box;
the torque bar/rod 4, 14, 24, 34 can have a length of 36″, 38″ or 48″;
the torque bar/rod 4, 14, 24, 34 can be L-shaped;
the torque bar/rod 4, 14, 24, 34 can be S-shaped, e.g., having a first section, a connecting perpendicular second section, and a third section, said third section being connected perpendicularly to said second section, wherein the preferred length of said first and third sections is 3″ and the preferred length of said second section is 4′;
the torque bar/rod 4, 14, 24, 34 and/or the valve operation head 3, 13, 23, 23′, 23″, 23′″ can comprise a ratchet-mechanism;
the torque bar/rod 4, 14, 24, 34 can be secured to the valve operation head 3, 13, 23, 23′, 23″, 23′, via a knob, positive locking pin, pop pin, spring loaded plunger pin, quick release pin, selector pin, wire lock, lynch pin, swell latch, wire rope, and/or spring pin;
instead of fixation knob 29, the valve operation head 3, 13, 23, 23′, 23″, 23′″ can comprise, for fixation of rail 27 to body 28, a spring loaded pin, a locking lever, and/or any other suitable fixation, arranged at a side or top of body 28;
the fixation knob 29 can be arranged on top of body 28;
for length adjustment, the valve operation head 3, 13, 23, 23′, 23″, 23′″ can comprise a track system or spring loaded adjustment system;
the prongs 25 of valve operation head 3, 13, 23, 23′, 23″, 23′″ can, instead of being welded to rail 27 and/or body 28, be formed integrally with rail 27 and/or body 28;
the valve key tool set can comprise two valve operation heads 3, 13, 23, 23′, 23″, 23′″, with U-shaped operating bars 30 of different size; and/or
the valve operation head 3, 13, 23, 23′, 23″, 23′″ can comprise at least one silicone rubber and/or paint grade rubber insert to enhance the friction between valve key 1, 11, 21 and a handle of a valve; the rubber or rubber insert can be located on inner surfaces of the prongs of the valve operation head 3, 13, 23, 23′, 23″, 23′.

1. Apparatus for opening and closing valves, said apparatus comprising:
a handle adapted to be turned by a user;
coupled to the handle, and generally perpendicular thereto, an elongated torque bar; and
coupled to the torque bar, and generally perpendicular thereto, an elongated valve operation head having at least one set of prongs adapted to grasp a handle of a valve.

2. The apparatus of claim 1 wherein the handle extends on both sides of the torque bar, thereby providing dual leverage.

3. The apparatus of claim 1 wherein the handle extends on just one side of the torque bar, thereby facilitating access to valves situated in quasi-inaccessible places.

4. The apparatus of claim 1 wherein the torque bar has an adjustable length.

5. The apparatus of claim 1 wherein the valve operation head has an adjustable length.

6. The apparatus of claim 5 wherein the adjustable length is provided by:
a rail having a plurality of notches wherein a set of prongs can be variously located along the length of the rail; and
a fixation knob adapted to secure the sliding prongs at a location selected by the user.

7. The apparatus of claim 1 wherein the valve operation head is offset from the principal axis of the torque bar.

8. The apparatus of claim 1 further comprising a mechanism to facilitate removeability and reconnection of the valve operation head with the torque bar.

9. The apparatus of claim 8 wherein the valve operation head comprises a cylindrical stub adapted to fit into a corresponding hollow receptacle of the torque bar.

10. The apparatus of claim 8 wherein the torque bar terminates in a cylindrical stub adapted to fit within a corresponding receptacle of the valve operation head.

11. The apparatus of claim 1 wherein the valve operation head comprises an expandable plate for adjusting the width between prongs.

12. The apparatus of claim 1 wherein the prongs comprise at least two pairs of opposed steel plates.

13. The apparatus of claim 1 wherein the valves are from the grouop of valves consisting of ball valves and butterfly valves.

14. A stand for a valve key assembly comprising:
an elongated post having first and second ends;
coupled to the first end, a set of prongs adapted to insert the stand into the earth; and
affixed to the second end, a holder for removably holding the apparatus described in claim 1.
